(19) United States
(12) Patent Application Publication
(10) Pub. No.: US 2023/0044326 A1
(43) Pub. Date: Feb. 9, 2023

(54) FASTENER FOR PYROTECHNICAL DISPENSER MAGAZINE

(71) Applicant: SAAB AB, Linköping (SE)

(72) Inventors: Christer Zätterqvist, Uppsala (SE); Gunnar Byström, Kungsängen (SE)

(21) Appl. No.: 17/791,347

(22) PCT Filed: Jan. 8, 2020
(86) PCT No.: PCT/SE2020/050003

§ 371 Date: Jul. 7, 2022

(51) Int. Cl. B64D 7/00; F16B 21/04

(52) U.S. Cl. CPC B64D 7/00; F16B 21/04; B64D 1/02

(57) ABSTRACT

A fastener for attaching a magazine to a breech plate, including a circular longitudinal body including at least one protrusion, an upper guide block having at least one slot adapted to cooperate with the protrusion, where the body is provided with a key grip at an upper end and a receiving opening at a lower end, where the fastener is provided with a release position in which the body is in a first rotational position, a set position in which the body is rotated by a first rotational degree from the release position, and a lock position in which the body is rotated by a second rotational degree from the release position. The advantage of the invention is that a magazine can be attached to and removed from an aircraft in a fast and easy way.

### TECHNICAL FIELD

The present invention relates to a fastener to be used for attaching a magazine holding pyrotechnical cartridges in a dispenser. The fastener provides a quick attachment and release of the magazine to and from the breech plate, and is provided with visual indication of the locked state.

### BACKGROUND ART

Arrangements for storing and launching payloads, such as countermeasures, which are designed to be mounted on aircrafts, are previously known. One such arrangement is a dispenser mounted on an aeroplane, which comprises an elongate body provided with at least one launch opening. The countermeasures are connected to a firing control unit for feeding firing signals to the countermeasures. The countermeasures can consist of passive means, such as chaff foil, but can also consist of for example IR flares, or other active measures. The countermeasures are stored in one or more magazines, where a magazine comprises a plurality of cartridges, with one countermeasure in each cartridge.

One problem with known dispensers mounted on aircrafts is that the magazine is attached to the breech plate with one or more threaded screws. It is thus often time-consuming to replace or exchange a magazine in the dispenser. It may also be required to use a torque wrench when mounting the magazine such that the proper torque is applied to the screw. When a magazine is attached to the breech plate of the dispenser, it is not possible to see if the screw is mounted with the correct torque. A second control of the mounting at an inspection thus requires a torque wrench as well.

EP 1873474 B1 discloses a dispenser arrangement for discharging countermeasure means on an aircraft. The magazine is fixed to the breech plate with a fixing bolt having an external thread. The fixing bolt is further provided with a handle.

Even though the known mounting method gives an acceptable result, there is still room for improvements.

### DISCLOSURE OF INVENTION

One object of the present invention is to at least partially eliminate the drawbacks associated with the solutions known in the prior art. Another object is to provide an improved fastener for a magazine having release position, a set position and a lock position. Another object of the invention is to provide a fastener for a magazine having a visual indication for the lock position. Another object is to provide a magazine comprising such a fastener. Another object of the invention is to provide an aircraft comprising such a magazine.

The solution to the problem according to the invention is described in the characterizing part of claim 1 for the fastener, in claim 12 for the magazine, in claim 13 for the magazine arrangement and in claim 15 for the aircraft. The other claims contain advantageous embodiments and further developments of the fastener and the magazine arrangement.

In a fastener for attaching a magazine to a breech plate, comprising a circular longitudinal body comprising at least one protrusion, a guide block having at least one slot adapted to cooperate with the protrusion, where the body is provided with a key grip at an upper end and a receiving opening at a lower end, the object of the invention is achieved in that the fastener is provided with a release position in which the body is in a first rotational position, a set position in which the body is rotated by a first rotational degree from the first position, and a lock position in which the body is rotated by a second rotational degree from the first position.

By this first embodiment of the fastener according to the invention, a fastener is provided which allows for a quick mounting and dismounting of a magazine in a dispenser. The fastener is provided with three distinct position, which are all stable states. When attaching a magazine to the breech plate, the fastener is set to the set position, in which the fastener will be able to hold the magazine to the breech plate with a small holding force, and in which an audible click is heard when the magazine is in position. The fasteners can then be set to the lock position without the risk of the magazine being dispositioned. In the lock position, a visual indication of the fastener provides a confirmation that the magazine is locked to the breech plate. When the magazine is to be released from the breech plate, the fastener is set to the release position in which there is no holding force of the fastener such that the magazine can be removed easily.

The body comprises in one example two circular parts, an upper sleeve and a lower lock sleeve. The two parts are concentric with part of the upper sleeve running inside the lower lock sleeve. The upper sleeve and the lock sleeve can thus move along a longitudinal direction independently of each other. This allows the upper sleeve to move from a recessed position in the release position and the set position to a raised position in the lock position, such that a visual indication is provided when the fastener is correctly locked. A spring is placed between the two parts, such that a small preload force is applied between the two parts.

The body further comprises a lower insert having an opening corresponding to a mating pin of the breech plate. The opening is provided with a locking means, in one example a number of small balls, preferably made from steel, adapted to interact with a circumferential groove of the mating pin. Other locking means, such as wedges or hatches, are also possible to use. The position of the lock sleeve will allow the steel balls to move freely in the release position, to move with some restriction in the set position or will completely block the movement of the steel balls in the lock position. The lower insert is attached to the lock sleeve through a holding screw and a first spring.

The upper sleeve and the lock sleeve are moved along a longitudinal direction by protrusions running in slots in the upper guide block. The body is provided with at least one pin running in one slot. In one example, the body is provided with three protrusions, a first protrusion running in a first slot, a second protrusion running in a second slot, and a third protrusion running in a third slot. The slots comprises inclined sections such that the upper sleeve and/or the lock sleeve is forced to move in the longitudinal direction depending on the rotational position of the body. In this way, a first rotation from the release position to the set position forces the lock sleeve downwards such that the movement of the steel balls are somewhat restricted, which provides an intermediate holding force allowing the fastener to snap onto a mating pin with an audible click sound. A second rotation from the set position to the lock position forces the lock sleeve further down, blocking the movement of the steel balls completely such that the fastener is locked to the mating pin. At the same time, the upper sleeve is forced upwards such that the top surface of the body will align with the top surface of the upper guide block. This will provide a visual indication of the locked state.

The key grip of the body may also provide a visual indication, depending on the type of key grip used. In the shown example, a square key grip is used. In the release position, the square key grip is aligned with the square upper guide block. In the set position, when the key grip has been rotated by, in one example, 30 degrees, the key grip is no longer aligned with the upper guide block, giving an indication that the fastener is in the set position. Since each predetermined position is a stable position, the fastener will remain in this position until it is rotated. By rotating the body further, the fastener will reach the lock position in which the key grip may be aligned with the upper guide block, and at the same time the top surface of the body is aligned with the top surface of the upper guide block.

The fastener may also be provided with a lower guide block that is adapted to support the lower end of the lock sleeve. The fastener is adapted to be fixedly attached to a magazine by the upper guide block and the lower guide block. The upper guide block and the lower guide block are therefore provided with threaded holes adapted to receive screws fixing the fastener to the magazine. In one example, a magazine comprises four fastener arranged at each corner of the magazine. This will allow for a secure attachment of a magazine to a breech plate.

### BRIEF DESCRIPTION OF DRAWINGS

The invention will be described in greater detail in the following, with reference to the embodiments that are shown in the attached drawings, in which

FIG. 1 schematically shows a side view of an aircraft provided with a magazine according to the invention,

FIG. 2 schematically shows a magazine according to the invention,

FIG. 3 schematically shows a breech plate for a magazine according to the invention,

FIG. 4 schematically shows a fastener in a release position according to the invention,

FIG. 5 schematically shows a fastener in a set position according to the invention,

FIG. 6 schematically shows a fastener in a lock position according to the invention,

FIG. 7 schematically shows a detail of the lower end of the fastener according to the invention, and

FIG. 8 schematically shows a magazine arrangement comprising a magazine locked to a breech plate with fasteners according to the invention.

### MODES FOR CARRYING OUT THE INVENTION

The embodiments of the invention with further developments described in the following are to be regarded only as examples and are in no way to limit the scope of the protection provided by the patent claims. References such as longitudinal, upper, lower, etc. refer to directions of a magazine positioned with the cartridge openings pointing upwards in a vertical direction. The magazine may of course be mounted on an aircraft in any suitable direction.

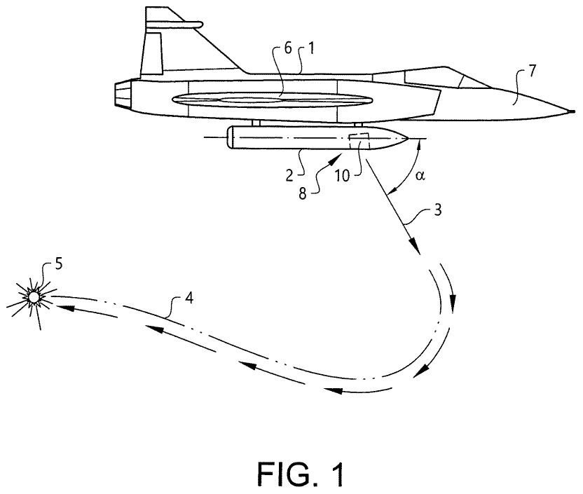

An aircraft 1 shown in FIG. 1 is provided with a dispenser 2 for storing and launching payloads, hereinafter described as countermeasures 5. The dispenser 2 has its longitudinal direction essentially coinciding with the longitudinal direction of the aircraft 1. An arrow 3 designates the direction of launch from the dispenser 2. The character a designates the launch angle relative to the direction of movement of the aircraft 1 when the countermeasures 5 are launched obliquely forwards and downwards The trajectory 4 for a launched flare 5 is indicated by a broken line. During the time from when a flare 5 is activated for launch to when it reaches the position shown in FIG. 1, sufficient time has elapsed for the flare 5 to have become a fully active decoy target in close proximity to the aircraft 1. In the example shown in FIG. 1, the dispenser 2 is placed under a wing 6 near its attachment to the main body 7 of the aircraft 1. It is also possible to place the dispenser 2 further out on the wing 6 or directly on the main body 7 of the aircraft 1, e.g. on top of the aircraft.

The countermeasures 5 are arranged in a magazine 10 mounted in the dispenser 2. The dispenser 2 is designed as an elongate body, provided with at least one launch opening 8 through which the countermeasures 5 are launched. A countermeasure 5 is stored in a cartridge 11 in the magazine 10. A magazine will hold several cartridges 11, e.g. between 20-60 cartridges or more, depending on the size of the magazine and of the size of each cartridge. When the cartridges in a magazine are used and empty, the magazine is removed from the dispenser and the cartridges are replaced. A magazine comprises fixed cavities, where a cavity can be reloaded with a new countermeasure. The cartridges 11 can be of the same size or of different sizes and can accommodate identical or different types of countermeasures 5.

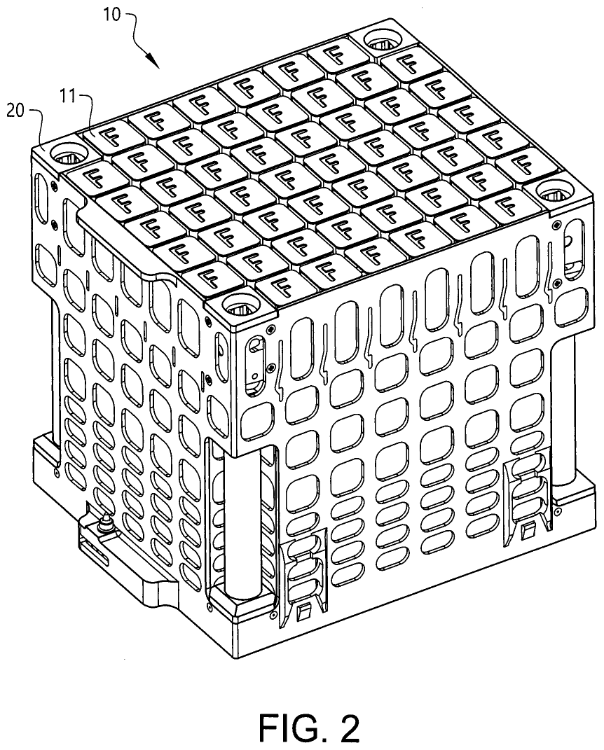

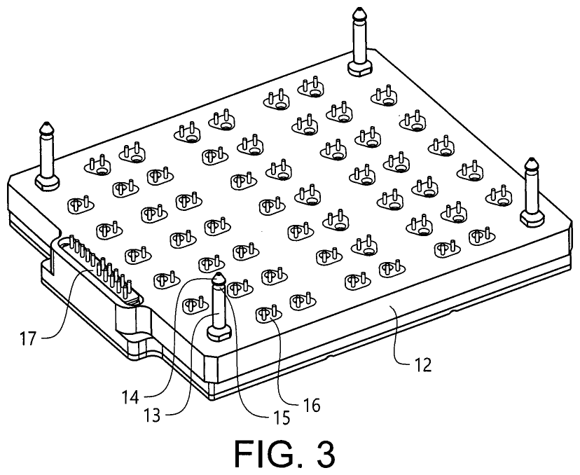

FIG. 2 shows a magazine 10 and FIG. 3 shows a breech plate to which a magazine is to be mounted. The magazine 10 is in the shown example rectangular having 7 rows and 8 columns. The cavities at the corners are provided with fasteners 20 having the same form factor as the cartridges 11. In the shown example, the fasteners are set in a set position, such that the magazine 10 can be mounted to a breech plate 12. The breech plate 12 comprises mating pins 13 at each corner, adapted to receive the fasteners of the magazine. The tip 14 of a mating pin is pointed to simplify the mating with a fastener. The mating pin is further provided with a circumferential groove 15, which together with locking means of the fastener, in the shown example steel balls 53, will provide the lock of the fastener to the mating pin. The breech plate comprises cartridge connectors 16 adapted to forward the launch signal to a cartridge and a control connector 17 that will connect the breech plate to the control system of the aircraft. The breech plate is fixedly mounted in a dispenser 2.

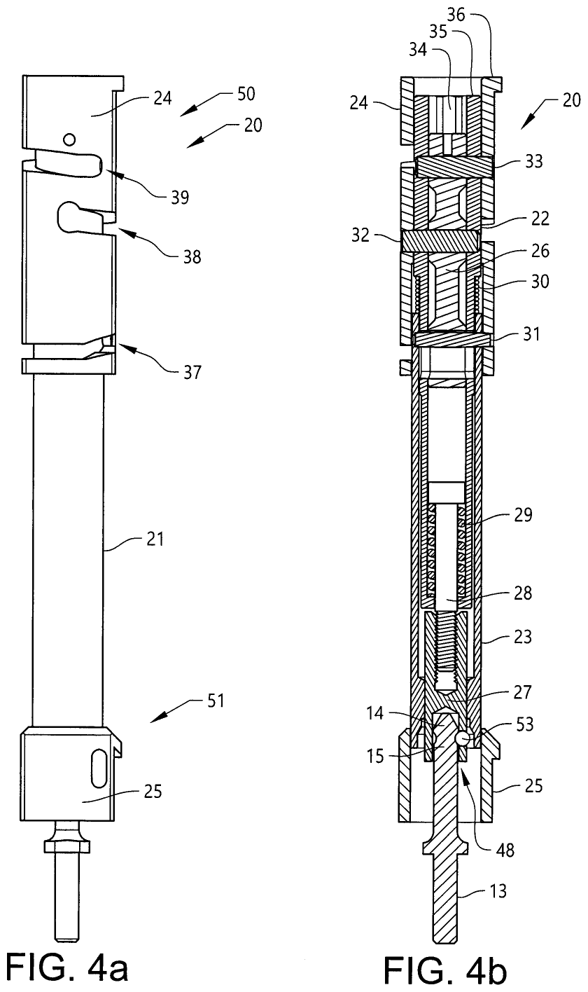

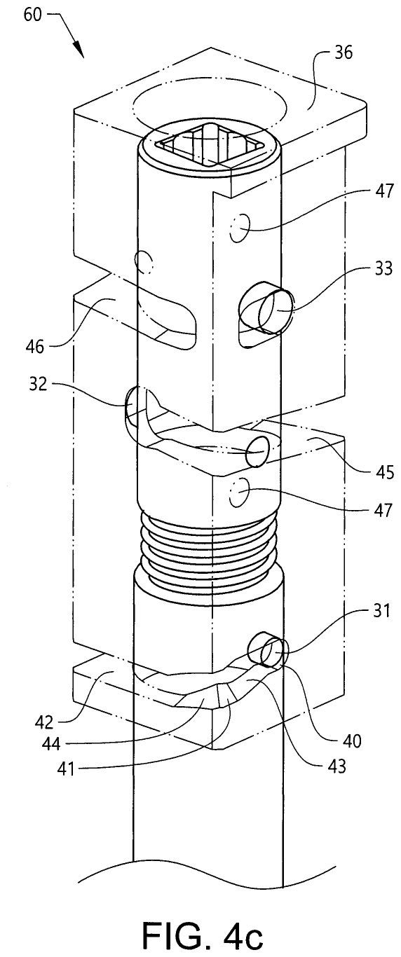

FIGS. 4a, b, c to 6a, b, c show an example of a fastener according to the invention. In FIG. 4, the fastener 20 is set in a release position 60, such that it can easily be removed from the breech plate. The shown fastener comprises a longitudinal circular body 21, a square upper guide block 24 and a square lower guide block 25. The circular body 21 comprises a circular upper sleeve 22 and a circular lower lock sleeve 23. The upper sleeve 22 and the lock sleeve 23 are concentric with a lower section of the upper sleeve 22 running inside the lock sleeve. The upper sleeve 22 and the lock sleeve 23 can thus move along a longitudinal direction independently of each other. This allows the upper sleeve 22 to move from a recessed position in the release position 60 and the set position 61 to a raised position in the lock position 62, such that a visual indication is provided when the fastener is correctly locked. A second spring, a lock sleeve spring, 30 is arranged between the upper sleeve and the lock sleeve, such that a small preload force is applied between the two circular sleeves.

The body 21 further comprises an upper insert 26 and a lower insert 27. The lower insert 27 is provided with a receiving opening 48 corresponding to a mating pin 13 of the breech plate 12. The receiving opening 48 is provided with a number of steel balls 53 adapted to interact with the circumferential groove 15 of the mating pin 13. The steel balls 53 are arranged in holes 58 in the lower insert, where the holes are shaped such that the steel balls cannot pass through them completely inwards, towards the inner of the lower insert. The position of the lower circular part 23 will allow the steel balls to move freely when the fastener is in the release position 60, to move with some restriction in the set position 61 and will completely block the movement of the steel balls in the lock position 62. The lower insert 27 is attached to the upper sleeve 22 through a holding screw 28 and a first spring 29.

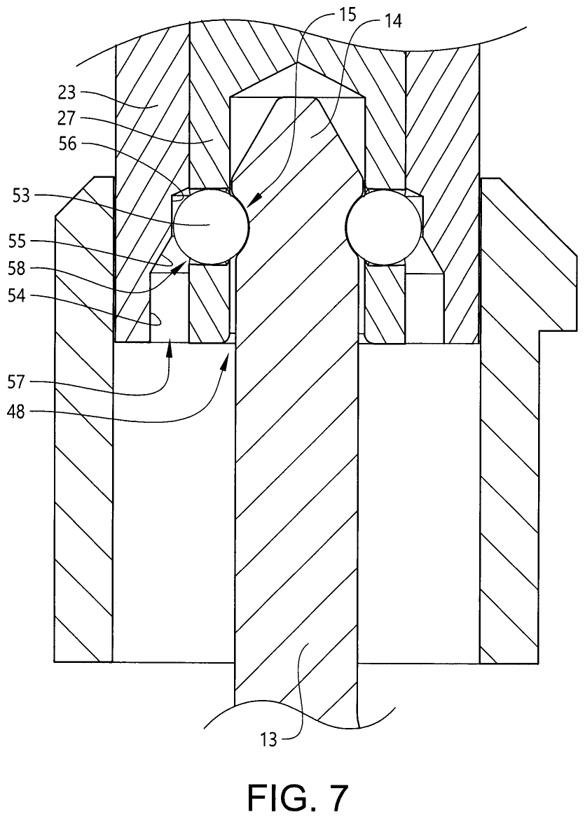

The lock sleeve is provided with a lower opening 57, shown in FIG. 7, where the opening is adapted to cooperate with the steel balls 53 of the lower insert. The lower opening 57 is provided with a first diameter 54, an inclined passage 55 and a second diameter 56. The first diameter 54 will allow the steel balls 53 to move outwards from the lower insert such that they are aligned with the inner wall of the lower insert. In this position, the steel balls will not interfere with a mating pin 13. This will allow the fastener to be removed from a mating pin without any holding force. This is the case when the fastener is set in the release position 60. The lock sleeve is here in its uppermost position.

When the fastener is set to the set position 61, the lock sleeve is moved downwards somewhat, such that the inclined passage 55 is arranged next to the steel balls 53. The inclined passage will push the steel balls inwards, such that they extend into the inner of the lower insert. When a fastener is pushed onto a mating pin, the steel balls will be pushed outwards by the mating pin, and the steel balls will bear on the inclined passage and will push the lock sleeve upwards, against the spring force from the lock sleeve spring 29, such that the steel balls can move outwards from the mating pin. When the fastener is in position on the mating pin, the lock sleeve is pushed downwards by the lock sleeve spring 29, such that the steel balls will extend inwards into the circumferential groove 15 of the mating pin 13.

When the fastener is set to the lock position 62, the lock sleeve is in its lowermost position, such that the second diameter 56 is arranged next to the steel balls 53. The second diameter does not allow the steel balls to move outwards at all, and holds the steel balls in the circumferential groove of the mating pin. The fastener is now locked to the mating pin.

The upper sleeve 22 and the lock sleeve 23 are moved along a longitudinal direction by protrusions running in slots in the upper guide block. In the shown example, the body 21 is provided with three protrusions, a first protrusion 31 running in a first slot 37, a second protrusion 32 running in a second slot 38, and a third protrusion 33 running in a third slot 39.

The first protrusion 31 is a pin arranged in the lock sleeve 23 and through the upper insert 26. The interaction between the first protrusion 31 and the first slot 37 will thus move the lock sleeve 23 in the longitudinal direction. The first slot 37 is provided with a first rest position 40, a second rest position 41 and a third rest position 42. Between the first rest position 40 and the second rest position 41, a first declination 43 is arranged, and between the second rest position 41 and the third rest position 42, a second declination 44 is arranged. In the release position 60, the first protrusion 31 will rest in the first rest position, such that the lock sleeve is in its uppermost position. This will allow the steel balls 53 to move freely relative the circumferential groove 15. The height of the slot in the first rest position corresponds to the diameter of the first protrusion, such that the lock sleeve cannot move in the longitudinal direction.

The second protrusion 32 is a pin arranged in the upper sleeve 22 and the upper insert 26. The upper insert 26 is thus fixed to the upper sleeve 22. The interaction between the second protrusion 32 and the second slot 38 will move the upper sleeve 22 in the longitudinal direction. The second slot 38 is provided with a first inclination 45. In the release position 60, the second protrusion 32 will be at the start of the first inclination 45, such that the upper sleeve 22 is in its lowest position.

The third protrusion 33 is a pin arranged in the upper sleeve 22 and the upper insert 26. The interaction between the third protrusion 33 and the third slot 39 will also move the upper sleeve 22 in the longitudinal direction. The third slot 39 is provided with a second inclination 46. In the release position 60, the third protrusion 33 will be at the start of the second inclination 46, such that the upper sleeve 22 is in its lowest position. The second slot 38 and the third slot 39 are parallel to each other. The second protrusion 32 and the third protrusion 33 will in this case both take up forces from a magazine acting on the fasteners. This will increase the shearing strength of the fastener.

The declined and inclined sections of the grooves forces the upper sleeve and/or the lock sleeve to move in the longitudinal direction depending on the rotational position of the body. In this way, a first rotation from the release position 60 to the set position 61 forces the lock sleeve 23 somewhat downwards such that the movement of the steel balls are somewhat restricted, which provides an intermediate holding force allowing the fastener to snap onto a mating pin with an audible click sound. A second rotation from the set position 61 to the lock position 62 forces the lock sleeve further down, blocking the movement of the steel balls completely such that the fastener is locked to the mating pin. At the same time, the upper sleeve is forced upwards such that the body top surface 35 of the body 21 will align with the upper guide block top surface 36 of the upper guide block 24. This will provide a visual indication of the locked state.

The key grip 34 of the body 21 may also provide a visual indication, depending on the type of key grip used. In the shown example, a square key grip 34 is used. In the release position 60, the square key grip 34 is aligned with the square upper guide block 24. In the set position, when the key grip has been rotated by, in one example, 30 degrees, the key grip is no longer aligned with the upper guide block, giving an indication that the fastener is in the set position 61. Since each predetermined position is a stable position, the fastener will remain in this position until it is rotated. By rotating the body further, the fastener will reach the lock position 62 in which the key grip may be aligned with the upper guide block, and at the same time the top surface 35 of the body is aligned with the top surface 36 of the upper guide block.

The shown fastener 20 is also provided with a lower guide block 25 that is adapted to support the lock sleeve 23 of the fastener. The fastener 20 is adapted to be fixedly attached to a magazine 10 by the upper guide block 24 and the lower guide block 25. The upper guide block and the lower guide block are therefore provided with threaded holes 47 adapted to receive screws fixing the fastener to the magazine.

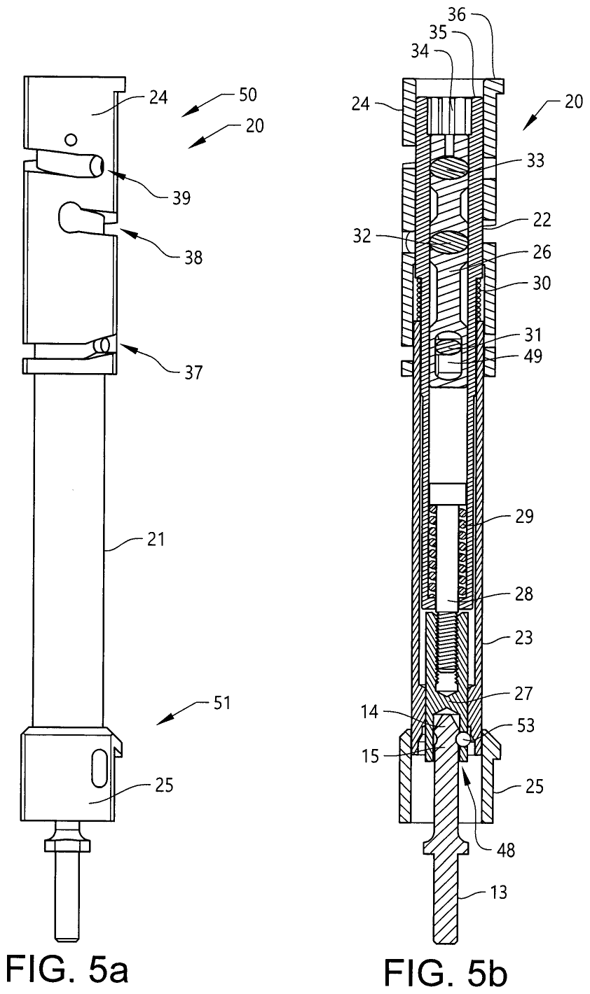

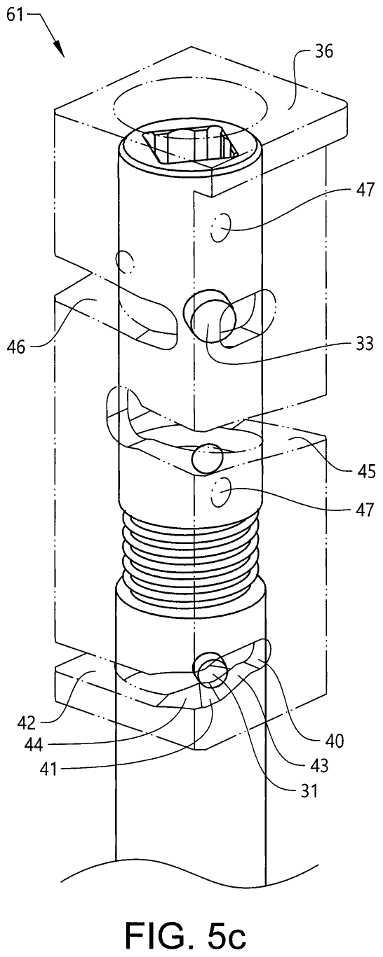

In FIG. 5, the fastener 20 is in the set position 61 in which the movement of the steel balls 53 are somewhat restricted, such that an intermediate holding force is applied to the steel balls relative the circumferential groove 15 of a mating pin 13. The fastener can thus be attached to the mating pin with an audible click sound, and will be held to the mating pin without falling off. This is of advantage if a magazine is mounted in a direction in which the cartridges point more or less downwards. The magazine can be attached to the breech plate and is then held in place without falling down when the magazine is secured to the breech plate by rotating the fasteners to the lock position. This allows that the magazine is mounted by one person, and avoids misalignment during the mounting process. The holding force in the set position is determined by the lock sleeve spring 29. The possible longitudinal movement of the lock sleeve in the set position is set by the height of the first slot 37 in the second rest position 41.

To arrive at the set position 61, the fastener is rotated from the release position 60 by a small degree, in the shown example 30 degrees in a clockwise direction. This will move the lock sleeve 23 somewhat downwards, thus restricting the movement of the steel balls 53 to some extent. The upper sleeve 22 does not move in the longitudinal direction between the release position and the set position.

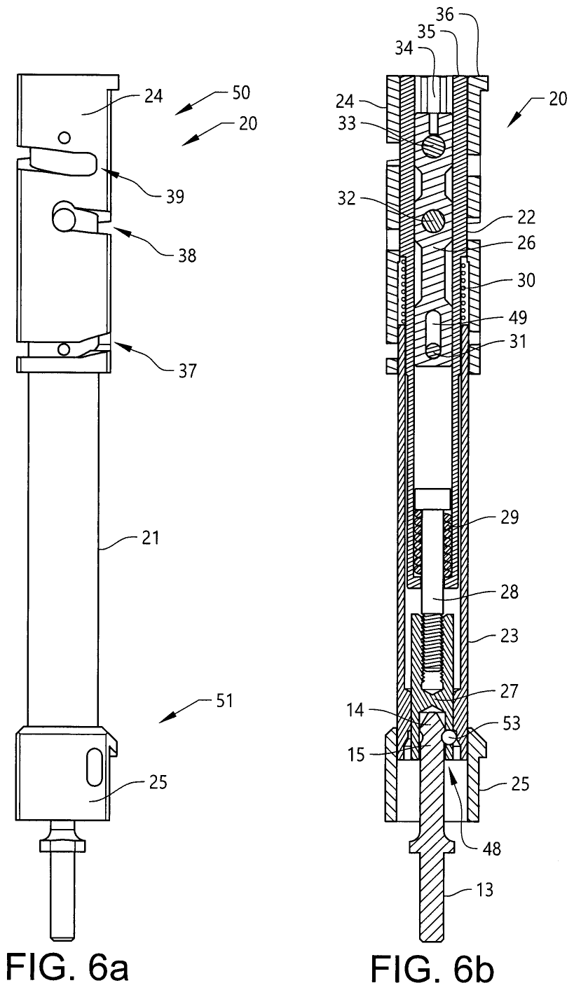

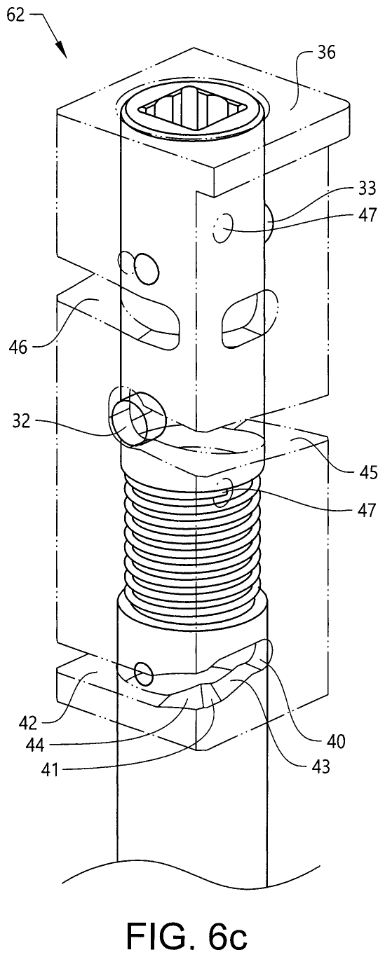

FIG. 6 shows the fastener 20 in the lock position 62. Here, the lock sleeve 23 is in its lowest position, blocking the movement of the steel balls 53, such that the steel balls are pushed in to the circumferential groove 15 of a mating pin 13. This locks the fastener 20 to the mating pin 13 and thus a magazine 10 to the breech plate 12. To arrive at the lock position 62, the fastener is rotated from the set position 61 by a larger degree, in the shown example 230 degrees in a clockwise direction. This will move the lock sleeve 23 downwards to its end stop, which is set by the third rest position 42 of the first slot 37, such that the movement of the steel balls 53 is restricted. The upper sleeve 22 is at the same time pushed upwards in the longitudinal direction by the interaction between the second protrusion 32 and the second slot 38 and the third protrusion 33 and the third slot 39. The first inclination 45 of the second slot 38 pushes the second protrusion 32 upwards, and the second inclination 46 of the third slot 39 pushes the third protrusion 33 upwards. The top surface 35 of the body 21 will now be aligned with the top surface 36 of the upper guide block 24.

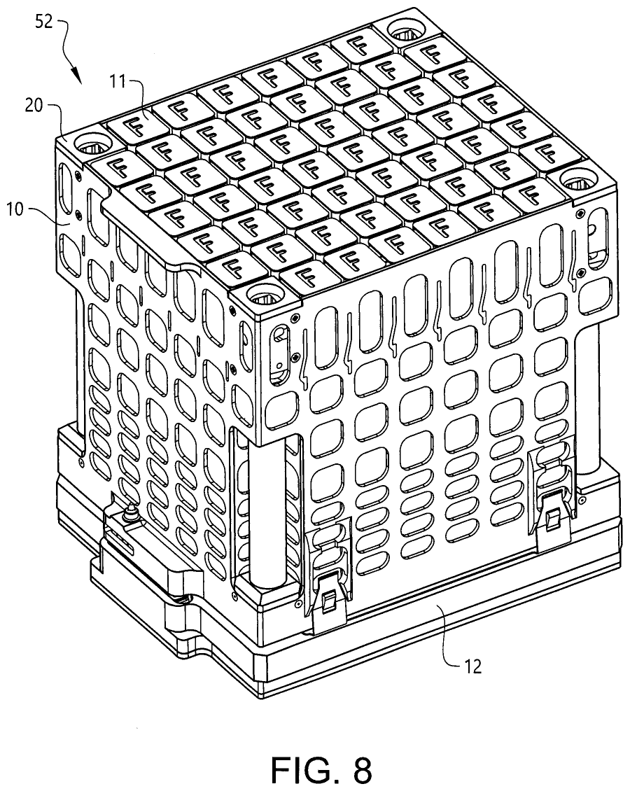

FIG. 8 shows a magazine arrangement 52 comprising a magazine 10 mounted and locked to a breech plate 12. In the shown example, the magazine comprises four fasteners arranged at each corner of the magazine. This will allow for a secure attachment of a magazine to a breech plate. It is of course possible to use other numbers of fasteners, e.g. depending on the size and weight of the magazine. In a small magazine holding only a few cartridges, a single fastener may suffice.

The invention is not to be regarded as being limited to the embodiments described above, a number of additional variants and modifications being possible within the scope of the subsequent patent claims. The fastener may e.g. use other locking means.

### REFERENCE SIGNS

1: Aircraft
2: Dispenser
3: Direction of launch
4: Trajectory
5: Countermeasure
6: Wing
7: Main body
8: Launch opening
10: Magazine
11: Cartridge
12: Breech plate
13: Mating pin
14: Tip
15: Circumferential groove
16: Cartridge connector
17: Control connector
20: Fastener
21: Body
22: Upper sleeve
23: Lock sleeve
24: Upper guide block
25: Lower guide block
26: Upper insert
27: Lower insert
28: Holding screw
29: First spring
30: Second spring
31: First protrusion
32: Second protrusion
33: Third protrusion
34: Key grip
35: Body top surface
36: Upper guide block top surface
37: First slot
38: Second slot
39: Third slot
40: First rest position
41: Second rest position
42: Third rest position
43: First declination
44: Second declination
45: First inclination
46: Second inclination
47: Threaded hole
48: Receiving opening
49: Opening
50: Upper end of fastener
51: Lower end of fastener
52: Magazine arrangement
53: Steel ball
54: First diameter
55: Inclined passage
56: Second diameter
57: Lower opening
58: Ball hole
60: Release position
61: Set position
62: Lock position

1. A fastener for attaching a magazine to a breech plate, comprising a circular longitudinal body comprising at least one protrusion, an upper guide block having at least one slot adapted to cooperate with the protrusion, where the body is provided with a key grip at an upper end and a receiving opening at a lower end, wherein the fastener is provided with a release position in which the body is in a first rotational position, a set position in which the body is rotated by a first rotational degree from the release position, and a lock position in which the body is rotated by a second rotational degree from the release position.

2. The fastener according to claim 1, wherein the body comprises an upper sleeve and a lower lock sleeve, where a lower section of the upper sleeve is arranged inside the lock sleeve.

3. The fastener according to claim 2, wherein the fastener comprises two protrusions where a first protrusion is fixed to the lock sleeve and a second protrusion is fixed to the upper sleeve.

4. The fastener according to claim 3, wherein the upper guide block is provided with a first slot adapted to cooperate with the first protrusion and a second slot adapted to cooperate with the second protrusion.

5. The fastener according to claim 4, wherein the first slot is provided with a declination and that the second slot is provided with an inclination.

6. The fastener according to claim 1, wherein the receiving opening is provided with a plurality of steel balls adapted to cooperate with a circumferential groove of a mating pin.

7. The fastener according to claim 2, wherein the lock sleeve is in an upper position when the fastener is in the release position, in an intermediate position when the fastener is in the set position, and in a lower position when the fastener is in the lock position.

8. The fastener according to claim 2, wherein the upper sleeve is in a lower position when the fastener is in the release position and in the set position, and in an upper position when the fastener is in the lock position.

9. The fastener according to claim 8, wherein the body top surface is aligned with the upper guide block top surface when the fastener is in the lock position.

10. The fastener according to claim 1, wherein the rotational angle between the release position and the set position is in the range between 20 to 45 degrees.

11. The fastener according to claim 1, wherein the rotational angle between the release position and the lock position is in the range between 90 to 270 degrees.

12. A magazine for storing a plurality of cartridges comprising countermeasures, wherein the magazine comprises at least one fastener according to claim 1.

13. A magazine arrangement, wherein the magazine arrangement comprises the magazine according to claim 12 and a breech plate.

14. The magazine arrangement according to claim 13, wherein the breech plate comprises at least one mating pin.

15. An aircraft, wherein the aircraft comprises at least one magazine arrangement according to claim 13.
